(19) United States
(12) Patent Application Publication
(10) Pub. No.: US 2007/0152788 A1
(43) Pub. Date: Jul. 5, 2007

(54) SUPERCONDUCTING ELECTROMAGNET

(75) Inventors: Paul Noonan, Oxfordshire (GB); David Alan Croft, Oxfordshire (GB)

Correspondence Address: MAINE & ASMUS, 100 MAIN STREET, P O BOX 3445, NASHUA, NH, 03061-3445, US

(73) Assignee: OXFORD INSTRUMENTS SUPERCONDUCTIVITY LIMITED, Oxon (GB)

(21) Appl. No.: 11/536,100

(22) Filed: Sep. 28, 2006

(30) Foreign Application Priority Data
Sep. 29, 2005 (GB) 0519882.5

(51) Int. Cl. H01F 6/00

(52) U.S. Cl. 335/216

(57) ABSTRACT

A superconducting electromagnet formed by a potted coil wound around an axis. Axially spaced ends of the coil are secured to respective support members to enable the electromagnet to be supported horizontally.

### RELATED APPLICATIONS

This application claims the benefit of G.B. Application No. GB0519882.5, filed Sep. 29, 2005. This application is herein incorporated in its entirety by reference.

### FIELD OF THE INVENTION

The invention relates to a superconducting electromagnet formed by a potted coil wound around an axis.

### BACKGROUND OF THE INVENTION

Superconducting resin-potted coils are well known and are used in the generation of high strength magnetic fields for use in magnetic resonance spectroscopy (MRS), ion cyclotron resonance (ICR) and the like.

Internal Lorentz stresses are contained by either the stiffness of the conductor/glass/resin composite on its own or in combination with an “over-binding” of stiff, high strength, material like stainless steel wire. To date many coils of this type have been mounted vertically using a stainless steel or composite ring bonded to the lower face of the coil. In a vertical magnet which is symmetrical around Z=0 there is little force on this single mounting and coils are known to work reliably so long as the interface between the coil and its mounting ring is carefully designed and fabricated.

However, in some applications, it is necessary to mount a resin-potted coil horizontally. If the coil is sufficiently long and heavy compared to its diameter excessive bending stress is produced in a conventional, single, base ring mount which can lead to failure during transportation or use, particularly upon the occurrence of a quench.

A possible solution is to use wax potted coil wound on a stiff stainless steel former. However, in some instances, the Lorentz stresses are too high to be tolerated by a wax potted coil.

### SUMMARY OF THE INVENTION

In accordance with the present invention, we provide a superconducting electromagnet formed by a potted coil wound around an axis, wherein axially spaced ends of the coil are secured to respective support members to enable the electromagnet to be supported horizontally.

The invention avoids any risk of damaging fragile components such as joint lead-outs, joint stalks and joint assemblies by providing additional support members.

Although spaced, individual support members could be used, in the preferred embodiments, the support members are integral parts of a tubular member extending around the electromagnet. This has the advantage of maintaining the symmetrical nature of the electromagnet by removing any problems of sag, which in turn can improve bore field homogeneity.

Typically, the cross-sectional shape of the tubular member matches that of the electromagnet and is preferably cylindrical.

Conveniently, the cylindrical tubular member extends beyond the ends of the coil so as to provide support members which are axially spaced from the coil. This assists connection of the tubular member to support points.

In addition, one end of the tubular member can be used to provide a support for joint assembly components. For example, an end of the tubular member may be provided with an inwardly extending flange to which joint assembly members can be coupled.

Preferably, the potted coil is adhered to the inside of the tube by a suitable adhesive either directly or indirectly via a reinforcement winding.

It is also convenient for the coefficient of thermal expansion of the tubular member to be greater than or equal to that of the potted coil. This is particularly useful where the potted coil is adhered to the tubular member since it will prevent cracking of the adhesive following changes in ambient temperature.

Preferably, the tubular member is non-magnetic although this is not essential.

Examples of materials from which the tubular member can be constructed include stainless steel, titanium and aluminium.

Although the electromagnet is designed to be used horizontally, it could, of course, be used vertically or at any other angle to the vertical.

An example of a superconducting electromagnet according to the invention will now be described and contrasted with a known electromagnet with reference to the accompanying drawings, in which:

### BRIEF DESCRIPTION OF THE DRAWINGS

FIG. 1 is a schematic cross-section through a known superconducting electromagnet; and,

FIG. 2 is a schematic cross-section through an example of an electromagnet according to the invention.

### DETAILED DESCRIPTION

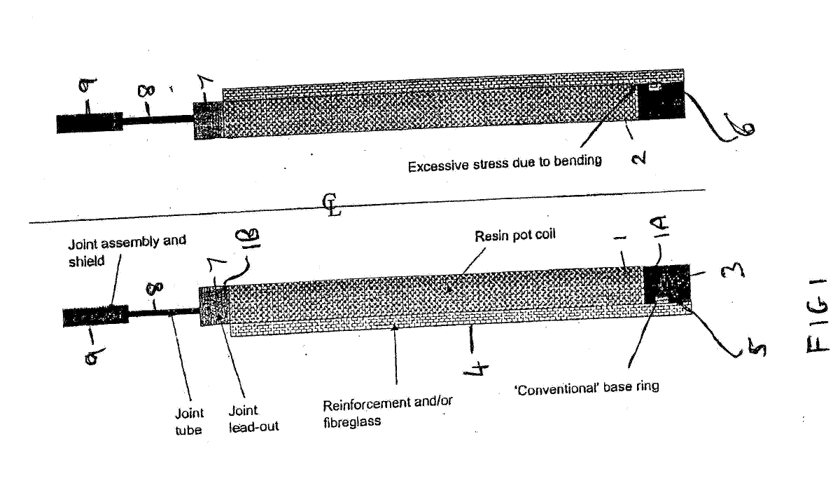

The superconducting electromagnet shown in FIG. 1 comprises a cylindrical, resin-potted coil 1 of superconducting wire which was wound around a mandrel and, after the potting compound solidified, the mandrel was removed. This left a bore 2. An annular, stainless steel support ring 3 is provided at the lower end 1A of the potted coil 1 (which is arranged with its axis vertical so that the other, upper end 1B of the coil is above the lower end). The potted coil 1 and support ring 3 are surrounded by a reinforcement layer 4 of fibre glass and/or an over-binding of stiff, high strength, material such as stainless steel wire in order to contain Lorentz stresses in use.

The lower end of the reinforcement 4 is formed with a radially inwardly extending flange 5 which keys into an annular slot 6 in the stainless steel ring 3.

The coil windings may be made of any conventional material such as niobium titanium or niobium tin or high temperature superconductivity materials. The internal diameter of the coil is typically in the range 200-210 mm and the outer diameter of the coil 1 about 250 mm. The reinforcement 4 has a typical thickness of about 1.5 mm while the length of the coil 1 may be about 600 mm. The electromagnet shown will typically form the inner magnet of a magnet assembly (not shown) which provides a resultant bore field of for example 12T suitable for applications such as ICR.

At the top of the potted coil 1 are provided a number of joint lead-outs 7 which are coupled by a joint tube 8 to respective joint assemblies 9. The joint assemblies 9 need to be spaced from the axial upper end of the potted coil 1 in order to reduce their exposure to the magnetic field. In order to support the joint assemblies 9, a separate support system is typically mounted on the top of the potted coil 1 but is not shown in FIG. 1 for clarity.

As explained above, if the potted coil 1 was to be used in a horizontal configuration, the stainless ring 3 would be subject to significant stresses and this can lead to failure during transportation or use. It is also not possible to utilize the joint lead-outs 7 to assist in the supporting process.

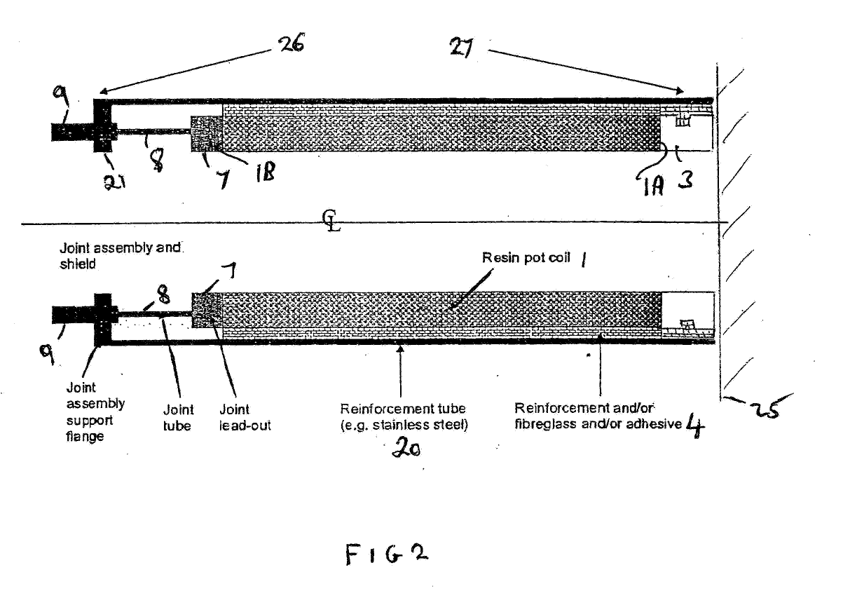

In the preferred example of the invention shown in FIG. 2, the potted coil 1, over-binding 4 and stainless steel support ring 3 are mounted in a cylindrical, stainless steel tube 20. It should be understood that those components in FIG. 2 which have been given the same reference numerals as in FIG. 1 will have substantially the same construction.

The tube 20 could also be made of other materials such as titanium or aluminium and will have a thickness of about 1.5 mm.

The stainless steel tube 20 supports the coil 1 and reinforcement 4 fully along its length and the internal surface of the tube 20 is adhered to the outer surface of the reinforcement 4 using a conventional adhesive such as Stycast 2850FT Blue which is either injected or vacuum pressure impregnated into the gap between the tube 20 and the reinforcement 4. The gap between the inner surface of the tube 20 and the outer surface of the reinforcement 4 will be about 1.5 mm although this will vary along the length of the reinforcement since this does not present a smooth surface.

The right hand end of the tube 20 projects beyond the end 1A of the coil and terminates flush with the axially exposed end of the support ring 3.

The left hand end of the tube 20 projects beyond the other end 1B of the potted coil 1 and is provided with an annular, internally projecting flange 21 having apertures (not shown) within which respective joint assemblies 9 are located. It will be seen, therefore, that the tube 20 provides a convenient way of supporting the joint assemblies 9 without the need for an additional support system.

The thermal coefficient of expansion of the material of the tube 20 is preferably equal to or greater than that of the potted coil and reinforcement 4 so as to prevent cracking of the adhesive.

There are number of different ways in which the arrangement shown in FIG. 2 can be mounted. One approach is to bolt the stainless steel ring 3 to an anchorage illustrated at 25 so that the assembly is cantilevered out from the anchorage. A further support (not shown) could be provided at the left hand end 26 of the tube 20. Alternatively, the assembly could be supported from the left and right ends 26 and 27 of the tube 20 from an anchorage (not shown) located above the assembly.

What is claimed is:

1. A superconducting electromagnet formed by a potted coil wound around an axis, said potted coil defining axially spaced ends, wherein said axially spaced ends of the potted coil are secured to respective support members to enable the electromagnet to be supported horizontally.

2. An electromagnet according to claim 1, wherein the support members are integral parts of a tubular member extending around the electromagnet.

3. An electromagnet according to claim 2, wherein the tubular member is cylindrical.

4. An electromagnet according to claim 2, wherein the tubular member extends beyond the ends of the potted coil.

5. An electromagnet according to claim 4, wherein one end of the tubular member provides a support for a joint assembly.

6. An electromagnet according to claim 5, wherein the joint assembly support is provided by a radially inwardly extending flange.

7. An electromagnet according to claim 2, wherein the coefficient of thermal expansion of the tubular member is greater than or equal to that of the potted coil.

8. An electromagnet according to claim 2, wherein the tubular member is adhered to the potted coil.

9. An electromagnet according to claim 1, wherein the potted coil is surrounded by a reinforcement winding.

10. An electromagnet according to claim 9, wherein the reinforcement winding is formed of stainless steel.

11. An electromagnet according to claim 9, wherein the tubular member is adhered to the potted coil via the reinforcement winding.

12. An electromagnet according to claim 1, wherein the support members are made of stainless steel, titanium or aluminium.

13. An electromagnet according to claim 1, wherein the support members are non-magnetic.
